(19) United States
(12) Patent Application Publication
(10) Pub. No.: US 2014/0156375 A1
(43) Pub. Date: Jun. 5, 2014

(54) SYSTEMS AND METHODS FOR PROCESSING COUPONS OVER A PAYMENT PROCESSING NETWORK

(71) Applicant: CCE Credit Card Enterprises, Inc., Edwardsville, IL (US)

(72) Inventors: Michael Gerard Vaughan, Bellmore, NY (US); James Francis Vaughan, Carlsbad, CA (US); Richard Henry Schmid, Roswell, GA (US); William Richard Restis, La Mirada, CA (US); William Richard Restis, II, San Diego, CA (US); Patrick Scott Lay, Edwardsville, IL (US)

(73) Assignee: CCE Credit Card Enterprises, Inc., Edwardsville, IL (US)

(21) Appl. No.: 14/055,502

(22) Filed: Oct. 16, 2013

Related U.S. Application Data
(63) Continuation-in-part of application No. 13/705,129, filed on Dec. 4, 2012.

(51) Int. Cl. G06Q 30/02

(52) U.S. Cl. CPC G06Q 30/0238
USPC 705/14.38

(57) ABSTRACT

A system of electronically requesting, generating and processing a coupon over a payment processing network is provided. During a sales transaction, a purchaser at a point of sale (POS) terminal provides a customer identifier using a card with a magnetic stripe which is read by a magnetic card reader and then transmitted across the payment processing network along with product identifiers on the products being purchased. The customer identifier includes a banking identification number (BIN) which is read by a first server in the payment processing network and then forwarded to a coupon server. The coupon server uses the customer identifier and product identifier to select any coupons that are available for use by the purchaser and transmits the coupons back to the POS terminal, where the coupons are applied to the sales transaction.

### CROSS-REFERENCES TO RELATED APPLICATIONS

This application is a continuation in part of U.S. application Ser. No. 13/705,129, filed on Dec. 4, 2012, the entirety of which is hereby incorporated by reference herein.

### BACKGROUND OF THE INVENTION

1. Field of the Invention

This invention relates to processing coupons electronically over a financial transaction network, and more particularly to requesting, generating, transmitting and processing coupons over a payment processing network as part of a payment process.

2. Description of Related Art

The use of coupons is difficult for both customers and merchants for many reasons. Customers using coupons during a purchase are generally required to bring a physical coupon to present to the merchant. Having to find, save and remember to bring the physical coupons to the merchant at the time that a product is being purchased is time-consuming and inconvenient for the consumer. Coupons often need to be organized by type, expiration date, the merchant's location where the coupon can be used, in addition to many other restrictions.

When the consumer does present the coupon to a merchant at the time of purchase, the coupon is manually scanned by a point of sale (POS) terminal, usually using an optical bar code reader which is configured to read a machine-readable code (ex. Universal Product Code (UPC)) present on the coupon. In some circumstances, the merchant will have to enter a coupon identification code into the POS if a UPC is not available or cannot be read. The merchant must also constantly update software for each POS terminal so that it has all of the possible coupons stored in a local database in order to determine if the coupons being presented are valid and can be accepted. The consumer is then given a discount on the purchase transaction immediately. However, if the coupon is from a manufacturer or seller of the purchased good or service, the merchant must request reimbursement for the cost of the coupon from that manufacturer. In order to process the coupon for reimbursement, the merchant must keep the physical coupons for separate processing, as the merchant is required to submit the coupons to a coupon processing center (redemption center) or the original manufacturer in order to be reimbursed for the coupon.

The reimbursement process requires a significant amount of time for the merchant and often must be done daily or monthly in order to keep up with the amount of incoming coupons. The reimbursement process is tedious, prone to errors, costly and slow, as it may take weeks for a merchant to be reimbursed for the coupons it has accepted.

It is therefore difficult, inconvenient and time-consuming for the consumer and the merchant to use coupons.

### BRIEF SUMMARY OF THE INVENTION

Embodiments described herein are directed to systems and methods for requesting, generating, transmitting and processing coupons electronically over a payment processing network. At a point of sale (POS) terminal one or more products being purchased are scanned into the POS terminal, after which a coupon card with an electronic customer identifier is read by a magnetic or optical reader to obtain consumer identification information. The consumer identification information is then transmitted across a payment processing network in a format similar to a credit or debit card number along with information on the products being purchased, such as, for example, one or several UPC numbers or codes, so that an initial processing server in the payment processing network routes the customer identification information and product information to a unique coupon server based on an identification code in the credit or debit card number, such as a banking identification number (BIN) number. The coupon server uses the consumer identification information and product information, such as, for example, one or several UPC numbers or codes, to identify any coupons that the customer can receive, and transmits coupon codes back to the POS terminal where the coupon is applied to the total amount due. A discounted total amount due is then determined, and the customer may then use any form of payment to pay for the transaction, including a credit card or debit card that uses the same payment processing network.

In one exemplary embodiment, a method of electronic processing of a coupon over a payment processing network comprises the steps of: obtaining a product identifier of at least one product; obtaining a customer identifier; transmitting the product identifier and the customer identifier over a payment processing network from a point of sale (POS) terminal to a coupon server, wherein at least a portion of the customer identifier is used as at least a portion of a payment processing destination address of the coupon server; identifying at least one coupon code applicable to the at least one product; transmitting the at least one coupon code to the POS terminal; and matching the at least one coupon code to the product identifier of the at least one product to apply a discount to the purchase price.

In another exemplary embodiment, a system of electronic processing of a coupon over a payment processing network comprises: a point of sale (POS) terminal communicatively coupled with the payment processing network; the POS terminal comprising: a product identification unit which obtains an identifier of at least one product; a customer identification unit which obtains a customer identifier; a transmission unit which receives the product identifier and the customer identifier from the product identification unit and customer identification unit and transmits the product identifier, such as, for example, one or several UPC numbers or codes, and customer identifier to the payment processing network; and a coupon server communicatively coupled with the payment processing network, comprising: a coupon code matching unit which selects at least one coupon code associated with the at least one product identifier; a coupon code transmission unit which transmits the at least one coupon code to the POS terminal for application by the coupon code application unit; and a coupon code application unit which applies at least one coupon code to a transaction to purchase at least one product.

In a further exemplary embodiment, a method of electronic processing of a coupon at a point of sale (POS) terminal comprises the steps of: initiating a purchase transaction; obtaining at least one product identifier, such as, for example, a UPC number or code; obtaining a customer identifier; parsing the customer identifier to obtain a purchaser identification number and a bank identification number (BIN); generating a payment processing network transaction comprising a banking identification number (BIN) as at least a portion of an address, the purchaser identification number and the at least one product identifier, such as, for example, a UPC number or code; sending the payment processing transaction over a payment processing network; pausing the purchase transaction; receiving an associated coupon code via the payment processing network with at least one of the at least one product identifiers; resuming the purchase transaction; and applying the coupon code to the purchase transaction.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. Specifically:

FIG. 1 illustrates a system for electronic processing of a coupon over a payment processing network, according to one embodiment of the invention;

FIG. 2 illustrates a point of sale (POS) terminal configured for electronic processing of the coupon, according to one embodiment of the invention;

FIG. 3 illustrates a coupon server configured for electronic processing of the coupon, according to one embodiment of the invention;

FIG. 4 illustrates a method of electronic processing of a coupon over a payment processing network, according to one embodiment of the invention;

FIG. 5 illustrates another method of electronic processing of a coupon over a payment processing network, according to one embodiment of the invention; and

FIG. 6 is a block diagram that illustrates an embodiment of a computer/server system upon which an embodiment of the inventive methodology may be implemented.

FIGS. 7a and 7b is a flowchart illustrating one embodiment of a process for processing a coupon over a payment processing network as performed by a point-of-sale (POS) terminal.

FIG. 8 is a flowchart illustrating one embodiment of a process for creating a user account.

FIG. 9 is a flowchart illustrating one embodiment of a process for processing a coupon overpayment processing network as performed by an authorizer.

### DETAILED DESCRIPTION OF THE INVENTION

In the following detailed description, reference will be made to the accompanying drawings. The aforementioned accompanying drawings show by way of illustration, and not by way of limitation, specific embodiments and implementations consistent with principles of the present invention. These implementations are described in sufficient detail to enable those skilled in the art to practice the invention, and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

The embodiments described herein provide for systems and methods of requesting, generating, transmitting and processing coupons over a payment processing network. A purchaser is not required to find coupons in advance of the purchase or bring in a physical coupon. The purchaser may be assigned a unique customer identifier that is entered at a point of sale (POS) terminal at the time of purchase and transmitted over the payment processing network to a uniquely-configured coupon server. Product identifiers may also be transmitted along with the customer identifier so that coupons can be specifically selected based on the products being purchased or the merchant where the products are being purchased. The customer identifier may be formatted with a specified numerical prefix that allows it to be transmitted and routed through the payment processing network as if it was a payment processing transaction. Once the customer identifier is received at the coupon server, the coupon server will determine applicable coupon codes to apply to the identified products and transmit matching coupon codes back to the POS terminal over the payment processing network. The electronic coupons will then be received at the POS terminal and applied to the appropriate products by matching coupon identification codes to the product identification codes. Once a discounted total is determined, the purchaser may then enter a method of payment at the POS terminal, even paying with a debit, credit or gift card using the same payment processing network used to obtain the coupon.

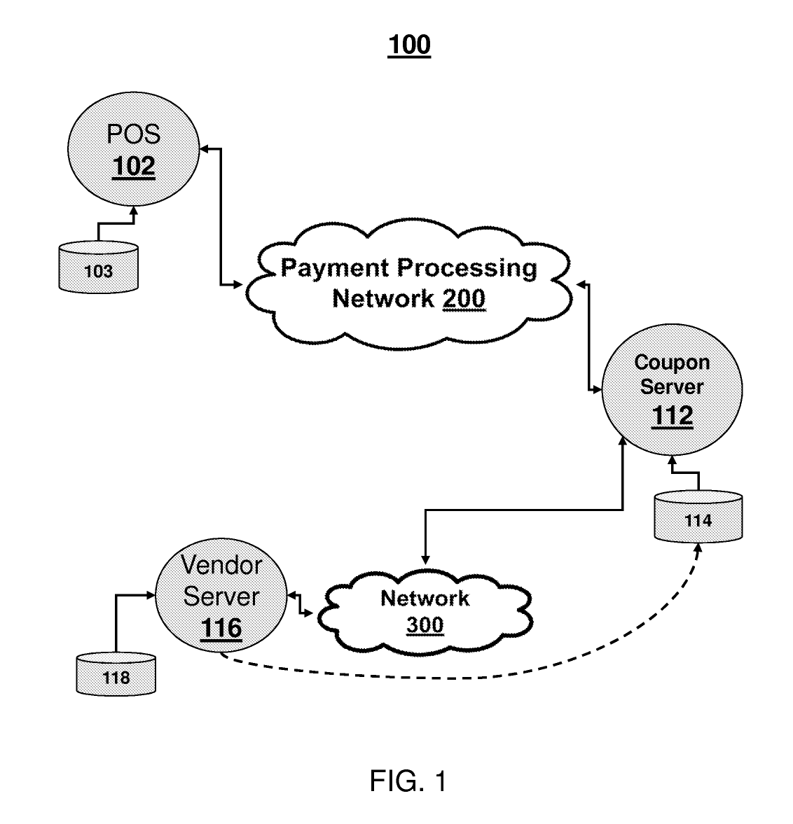

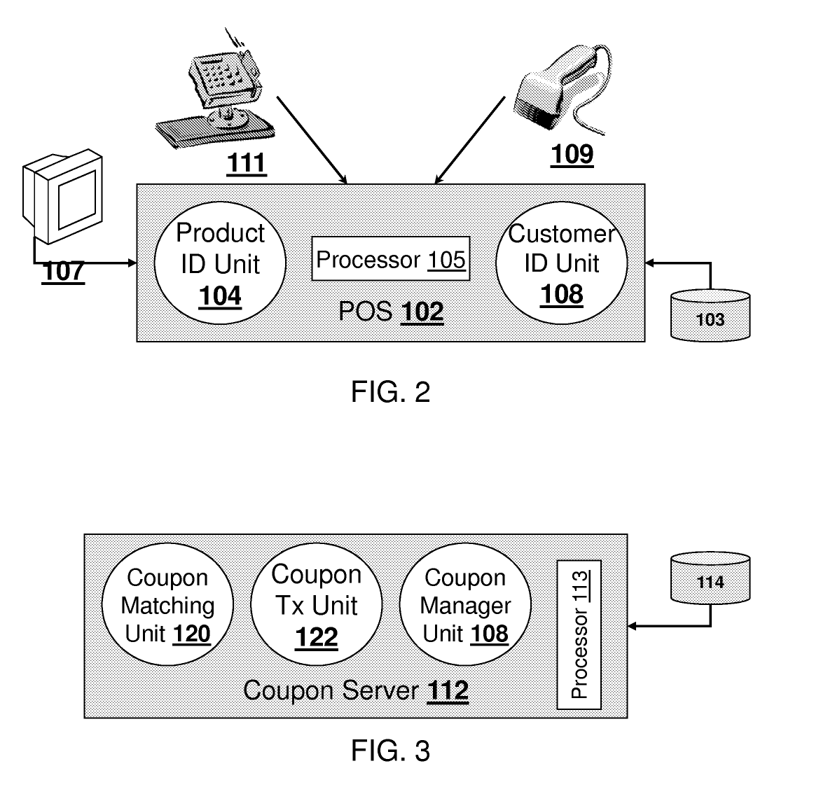

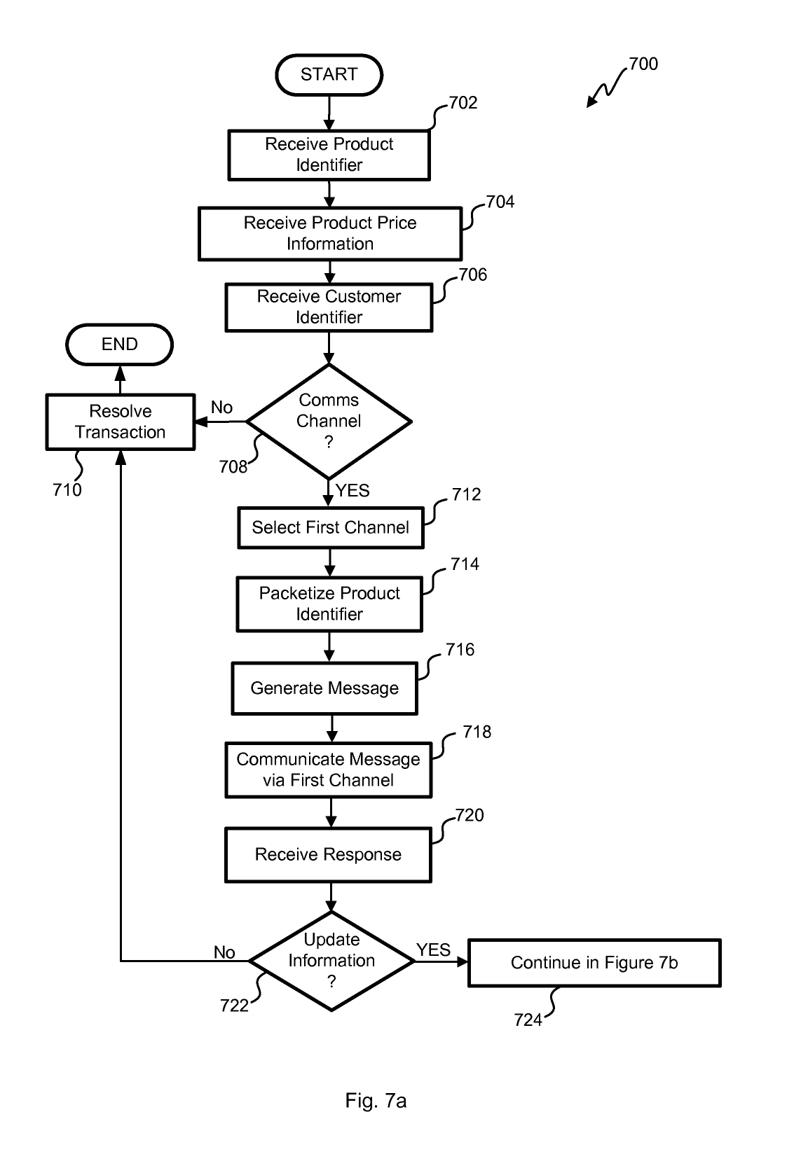

FIG. 1 is a block diagram of a system 100 for electronic processing of a coupon over a payment processing network, in accordance with one embodiment of the invention. A purchase transaction between a purchaser and a merchant begins at a point of sale (POS) terminal 102, where the purchaser brings at least one product to be purchased to the merchant in order to pay for the at least one product. The POS terminal 102 may be a computer with a memory, processor 105, attached display 107 and a plurality of input devices 109. A detailed configuration of the POS terminal 102 is illustrated by the computer system in FIG. 6 and described further below. A database 103 connected with the POS terminal 102 may store information needed to carry out a purchase transaction. The product may be goods or services, but is not limited thereto. As shown in FIG. 2, several software units may be provided at the POS terminal 102, including a product identification unit 104 that will obtain a product identifier to identify the at least one product being purchased using the input device 109 to input the product identifier. In one embodiment, one type of input device 109 is an optical scanner which optically reads a bar code, such as a Universal Product Code (UPC). The POS terminal 102 will look up the bar code in the database 103 to identify the product and the price.

Once the product or products have been identified, the purchaser may present a customer identifier which may be read by a customer identification unit 108 at the POS terminal 102. In one embodiment, the customer identifier is a number which may be stored on a plastic card with a magnetic strip similar to a credit card, so that the customer identifier may be read by an input device 109 such as a magnetic card reader 111 connected with the POS terminal 102. In another embodiment, the customer identifier may be stored on a card with an RFID or NFC transmitter and read by an appropriately configured input device 109. In a further embodiment, the customer identifier may be stored electronically on a portable electronic device, such as a smartphone or tablet, where it may be displayed on a display screen of the portable electronic device or transmitted to the POS terminal 102 using wireless or optical transmission, such as infrared, Bluetooth®, Wi-Fi, RFID, NFC, etc. In addition, in one embodiment, the customer identifier may be integrated with an application or program running on the portable electronic device, and may be integrated with a mobile payment service such as Google Wallet®. The customer identifier may include a number unique to the purchaser, a membership club, company, or any organization which may provide coupons. The customer identifier may also include additional information on a type of membership level, benefits or other purchaser profile information.

In one embodiment, the customer identifier is formatted in order to be read and understood by servers on a payment processing network 200. The customer identifier may therefore include a banking identification number (BIN) in the first five or six digits of a numerical sequence, as the BIN will indicate to the payment processing network 200 where the customer identifier and related purchase information should be sent in order to obtain one or more electronic coupons.

The customer identifier and purchase identifiers are then transmitted from the POS terminal 102 on the payment processing network 200, as understood by one of skill in the art, to a coupon server 112, which is the identified destination extracted from the BIN. The payment processing network 200 identifies the BIN number in the incoming transmission and then accesses a database of all of the names and server addresses of all possible entities which belong to the payment processing network 200, such as credit, debit or gift card issuers that may have issued a credit, debit or gift card. In one embodiment, the BIN number in the customer identifier corresponds to the coupon server 112, which may be managed by an entity responsible for generating, matching and transmitting coupons which can include, for example, one or several coupon codes. The BIN number is then matched with the corresponding entity managing the coupon server 112, after which the payment processing network 200 identifies the server address of the coupon server 112 and transmits the customer identifier and product identifier to the coupon server 112.

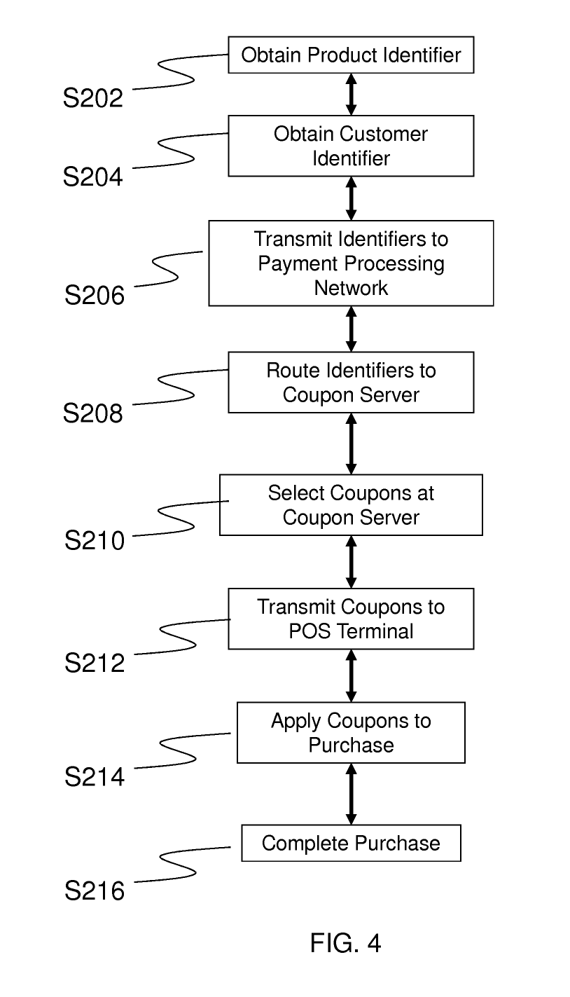

The coupon server 112 may be a computer with a memory and processor 113, a detailed configuration of which is illustrated by the computer system in FIG. 6 and described in further detail below. The coupon server 112 uses the customer identifier and product identifier to match appropriate coupon codes which correspond to the products being purchased, the merchant where the products are being purchased or even to a specific purchaser. For example, a coupon code may pertain to a specific product, all products of a specific brand, a specific merchant, etc., as determined by UPC coupon codes or otherwise. As described above, the customer identifier and product identifier may contain unique numerical codes corresponding to a specific purchaser, the specific products, the specific merchant, etc. As illustrated in FIG. 3, the coupon server 112 will access a coupon database 114 which stores information on the coupons, purchasers, merchants and the rights that purchasers have to access specific coupons. The coupons may be restricted or provided based on any type of criteria, including purchaser location, time, type of merchant, number of products being purchased, purchasing history, merchant promotions, purchaser memberships in discount clubs or organizations, etc. The coupon database 114 may also store the plurality of rules and restrictions in addition to the coupons themselves, and a coupon matching unit 120 at the coupon server 112 will then use the customer identifier, product identifiers and any other information to determine the coupons that should be provided to the customer.

Once the coupons are selected by the coupon matching unit 120, coupon codes corresponding to each coupon are transmitted by a coupon server transmission unit 122 at the coupon server 112 back to the POS terminal 102. The coupons are therefore electronic and are transmitted in the form of unique coupon codes, in the form of UPC codes or otherwise, that can be translated by the POS terminal 102 into the specific discount or promotion to apply to the purchase. In one embodiment, the process of transmitting the customer identifier and purchase identifier across the payment processing network 200 is asynchronous, in that the POS terminal 102 which transmits the identifiers will await a response from the coupon server 112 before continuing to process the transaction. The payment processing network 200 may also operate asynchronously and await a response from the coupon server 112 once the identifiers are transmitted, which will make it easy for the payment processing network 200 to identify where to send the selected coupons codes that are received from the coupon server 112.

Once the POS terminal 102 receives the selected coupon codes, the POS terminal 102 inputs the coupon codes, matches the coupon codes to associated product codes, and applies the appropriate discounts to the products being purchased. When the discounted total purchase amount is determined, the POS terminal 102 may then complete the payment of the purchase as it normally would, for example by accepting payment from the purchaser using a credit, debit or gift card that is swiped at an input device 109 such as the magnetic card reader 111, and then transmitted by the POS terminal 102 across the payment processing network 200 to an authorizer at a banking server to complete a normal payment process.

In one embodiment, the POS terminal 102 may be configured with specific software that will recognize the input of the customer identifier at an input device 109 such as the magnetic card reader 111. The software may be installed along with existing POS terminal software as an add-on or patch to the existing POS terminal software, or the POS terminal 102 may be loaded with proprietary software which includes the capability to recognize the customer identifiers and transmit the customer identifier, product identifiers and other relevant purchase information across the payment processing network 200.

In one embodiment, a vendor may interact with the coupon server 112 remotely over a network 300, such as the Internet, in order to create and manage coupons. The coupon server 112 may therefore provide a remote user interface where the vendor can access the list of current coupons to create new coupons, delete old or expired coupons and manage access to coupons based on one or more factors. In an alternate embodiment, the coupon server 112 may be connected with one or more vendor servers 116 over a separate network 300, such as the Internet, in order to electronically receive updated lists of coupons. The vendor server 116 may be operated by a product manufacturer which is responsible for creating the coupons. The vendor server 116 may then create and store a list of valid coupons in its database 118, and the coupon server 112 may then request or automatically receive the latest updated coupons from the vendor server 116. In one embodiment, the vendor server 116 may communicate directly with the coupon database 114 to update the list of coupons available to consumers, or, the vendor server 116 could be located within the coupon server 112.

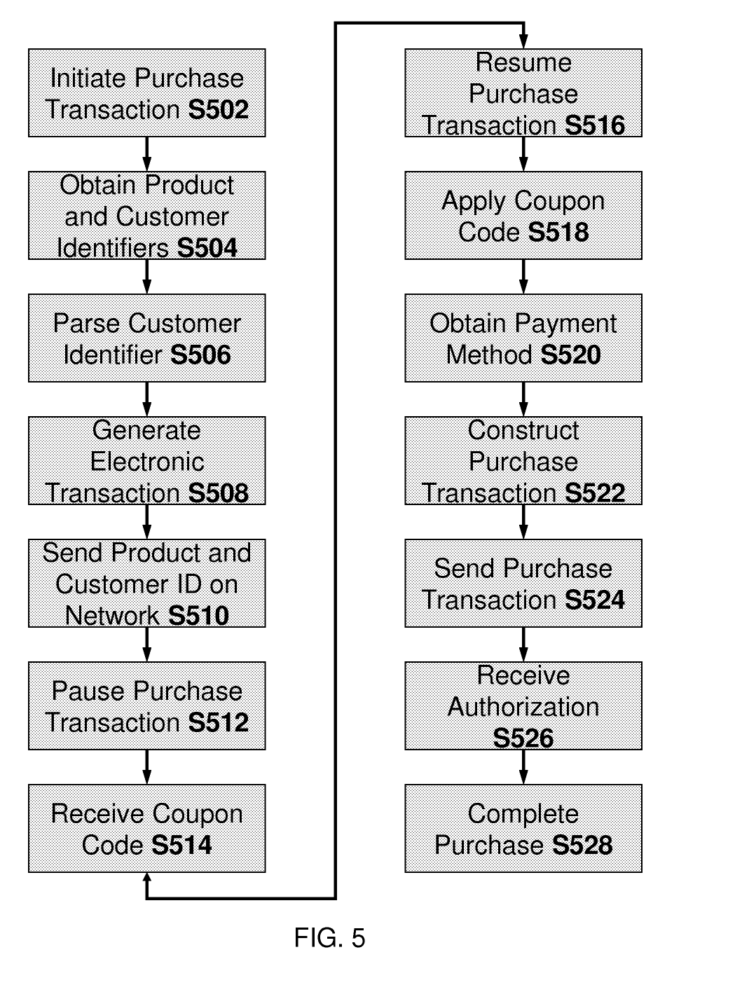

FIG. 4 illustrates one embodiment of a method of electronic processing of a coupon over a payment processing network. In a first step S202, a product identifier is obtained for at least one product. In a second step S204, a customer identifier is obtained. Next, in step S206, the product identifier and customer identifier are transmitted over a payment processing network from a point of sale (POS) terminal to a coupon server. In step S208, at least a portion of the customer identifier is used as at least a portion of a payment processing destination address in order to route the identifiers to a coupon server. At least one coupon applicable to the at least one product is selected at the coupon server in step S210, after which, in step S212, the at least one selected coupon is transmitted to the POS terminal. In step S214, the at least one selected coupon is applied to a price of the at least one product, after which the purchaser may complete the purchase (S216) by any form of payment method, even by using the same payment processing network used to obtain the at least one selected coupon.

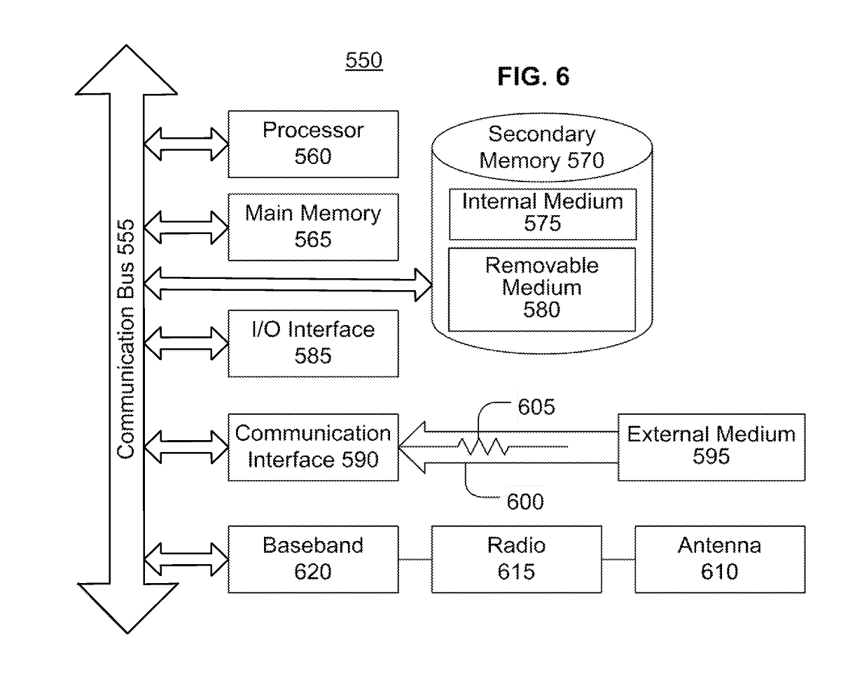

FIG. 5 illustrates another embodiment of a method of electronic processing of a coupon over the payment processing network. In a first step S502, a purchase transaction is initiated at the POS terminal. Next (S504), a product identifier is obtained, such as by scanning a UPC code on a product tag, and a customer identifier is obtained, such as by scanning a special coupon card with a barcode, magnetic strip or other type of machine-readable code. In step S506, the customer identifier is parsed to obtain a customer identification number and a bank identification number (BIN). A payment processing network transaction may then be generated (S508) comprising the BIN, customer identification number and product identifier. The BIN may contain at least a portion of an address which corresponds to the destination address for the payment processing network transaction. The payment processing network transaction is then sent over the payment processing network in step S510. Meanwhile, the purchase transaction is paused (S512) while the payment processing network transaction is being carried out. One or more coupon codes are received from the coupon server in step S514, after which the payment processing network transaction is resumed (S516). Next, in step S518, one or more of the coupon codes are applied to the purchase transaction in order to discount the purchase price of the products being purchased. Once the discounts are applied, a payment process is initiated where a method of payment, such as a credit, debit or gift card number, is obtained from the customer (S520), a purchase transaction is constructed (S522). The purchase transaction is sent across the payment processing network (S524) to a banking server to authorize the use of the method of payment, authorization is received (S526) and the purchase is completed (S528).

### Computer-Implemented Embodiment

FIG. 6 is a block diagram illustrating an example wired or wireless system 550 that may be used in connection with various embodiments described herein. For example the system 550 may be used as or in conjunction with the system 100 for electronic processing of a coupon as previously described with respect to FIGS. 1-3. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include an internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

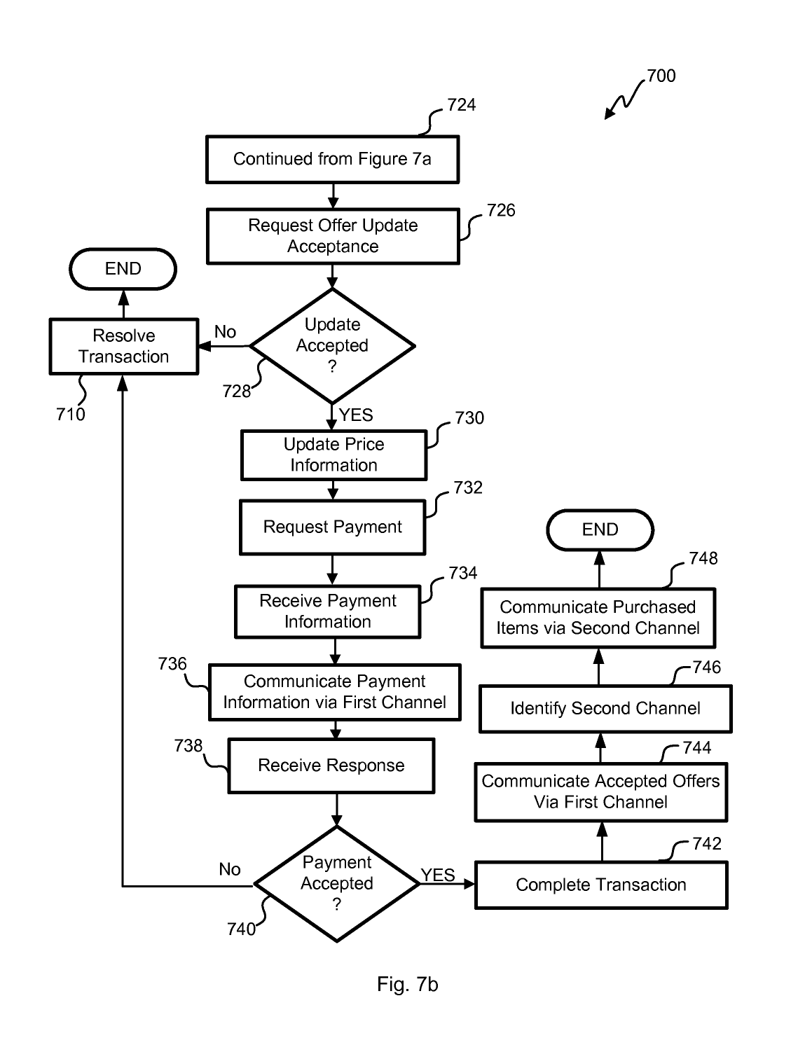

With reference now to FIGS. 7a and 7b a flowchart illustrating one embodiment of a process 700 for processing a coupon over a payment processing network as performed by a point-of-sale (POS) terminal is shown. The process 700 begins at block 702 wherein a product identifier is received. In some embodiments, the product identifier can comprise one or several product identifiers. In some embodiments, the product identifier can be received via one of the input devices 109. In some embodiments, this input device 109 can be a scanner that can be used to, for example, scan an identifying feature and/or marking on the one or several products which marking can be, for example, a computer readable code, including a barcode. In some embodiments, the input device 109 can be a feature configured to allow a user to directly input the product identifier into the POS terminal, the feature including, for example, a keypad, a microphone, a touch screen, or the like. In some embodiments, the product identifier can be a text string that can identify the product. In some embodiments, this text string can uniquely identify the product and can include, for example, a UPC code.

After the product identifier has been received, the process 700 proceeds to block 704 wherein product price information is received. In some embodiments, the product identification unit 104 can receive the product identifier and can identify the product associated with the product identifier. In some embodiments, this can include searching one or several product databases for pricing information associated with the identified product. After the product price information has been received, the process 700 proceeds block 706 wherein the customer identifier is received. In some embodiments, the customer identifier can include an identification portion that identifies the user and/or account, and a routing portion that identifies the authorizer. In some embodiments, the routing portion of the customer identifier can comprise a BIN. In some embodiments, the routing portion can be received simultaneous with the identification portion, and in some embodiments, the routing portion can be receive separate from the identification portion. Thus, in one embodiment, for example, the identification portion of the customer identifier can be used to retrieve the BIN from a BIN database within, for example, the customer identification unit 108.

In some embodiments, the customer identifier can be used to identify a discount account that can be associated with the customer identifier. In some embodiments, the association between the customer identifier and the discount account can be locally stored at the POS terminal 102, and in some embodiments, the association between the customer identifier and the discount account can be stored remotely from the POS terminal 102 such as, for example, at the database 103. In some embodiments, for example, the connection between the user account and the discount account can be stored at the coupon server 112 and/or the coupon database 114 associated with the coupon server 112. If the association between the customer identifier and the discount account is locally stored at the POS terminal 102 or at the database 103, the discount account can be identified.

In some embodiments, the customer identifier can uniquely identify the customer and/or uniquely identify an account. In some embodiments, and as discussed above, the customer identifier can be received by the customer identification unit 108 that can be, for example, a component of the POS terminal 102 and/or in communicating connection with the POS terminal 102. The customer identification unit 108 can receive the customer identifier in a number ways. In some embodiments, for example, the customer identifier can be embodied in a computer readable code, a magnetic strip, a radio communication, a text string, or in any other desired form or format. In some embodiments, customer identification unit 108 can comprise one or several sensors, scanners, receivers, transmitters, and/or the like that can receive the customer identifier. In some embodiments, the customer identification unit 108 can be a feature configured to allow a user to directly input the product identifier into the POS terminal including, for example, a keypad, a microphone, a touch screen, or the like.

After the customer identifier has been received, the process 700 proceeds to decision state 708 wherein it is determined if the POS terminal 102 has one or several communicating connections with other systems and/or devices. If it is determined that the POS terminal 102 does not have any communicating connections, then the process 700 proceeds block 710 wherein the transaction is resolved either by the abandonment of the transaction or the completion of the transaction. Returning again to decision state 708, if it is determined that there are one or several communicating connections from the POS terminal 102, then it is determined if one of those communicating connections links the POS terminal to the payment processing network 200 which can be, for example, a merchant bank. If the POS terminal to does not have a channel 600 connecting to the payment processing network 200, the process 700 proceeds block 710 and continues as outlined above.

If it is determined that POS terminal 102 has a channel 600 connecting to the payment processing network 200, then the process 700 proceeds to block 712 wherein the channel connecting to the payment processing network 200, which channel is also referred to herein as the first channel, is selected. In some embodiments, the selection of this first channel can include the establishment of the first channel with the payment processing network 200. In some embodiments, this can include the establishment of a secure first channel via, for example, encryption, tunneling, or the like. In some embodiments, the first channel can comprise a physically distinct communication channel such as, for example, a single purpose wired connection between the POS terminal 102 and the payment processing network 200, and in some embodiments, the first channel can comprise a distinct line of communication created within a non-unique communication network such as, for example, an encrypted connection via the internet and/or a tunneled connection via the internet or via a wireless network.

After the first channel has been selected, the process 700 proceeds to block 714 wherein the product identifier is packetized. In some embodiments, for example, a plurality of product identifiers can be packetized into single packet and can be formatted for communication and/or transmission via the first channel. In some embodiments, the packetization of the product identifier can be performed by the processor 105 of the POS terminal 102.

After the product identifier has been packetized, process 700 proceeds to block 716 wherein a message is generated. In some embodiments, the message can comprise information including the customer identifier and the packetized product identifier that can be communicated to the payment processing network 200 via the first channel. In some embodiments, the generation of the message can include encryption of data to be sent in the message, the formatting of data to be sent in the message, or other similar operations.

After the message has been generated, the process 700 proceeds to block 718 wherein the message is communicated via the first channel. In some embodiments, the message can be communicated via the first channel by the communication interface 590. After the message has been communicated via the first channel, the process 700 proceeds to block 720 wherein a response is received. In some embodiments, the response can be received via the first channel and via the communication interface 590. In some embodiments, the response can be received from payment processing network 200. The response can include information identifying offers and/or adjustments to be applied to the price associated with the product and/or products. In some embodiments, the response can include one or several coupons, coupon codes, discounts, refunds, or the like. In some embodiments, the response can indicate that there is no available adjustment to the price associated with the product and/or products.

After the response has been received, the process 700 continues to decision state 722 wherein it is determined if price information associated with the product and/or products is updatable based on the received response. In some embodiments, this can include determining whether there received response includes information that will result in a change in the price associated with the product and/or products. If it is determined that price information is not updatable, then the process 700 returns to block 710 and continues as outlined above.

If it is determined the price information is updatable, then the process 700 continues to block 724 and continues to FIG. 7b. Referring now to FIG. 7b, the process 700 continues to block 726 wherein offer update acceptance is requested. In some embodiments, for example, this can include requesting the purchasing user to indicate whether to accept the updates to the price of the product and/or products that would arise from the application of the information received in the response in block 720. In some embodiments, this request can be made via the I/O interface 585.

After the acceptance of the offer update has been requested, process 700 proceeds to decision state 728 wherein it is determined if the customer user indicated acceptance the offer update. In some embodiments, this can include receiving a customer user response via the I/O interface 585 and determining whether the customer user response indicates the customer user's acceptance. This determination can be performed by a component of the POS terminal 102 including, for example, the processor 105. If the update is not accepted, then the process 700 returns to block 710 and continues as outlined above.

If the update is accepted, then the process 700 proceeds to block 730 wherein the price information is updated. In some embodiments, the price information can be updated by the processor 105 of the POS terminal. This updating of the price information can be used to calculate the payment due in order to complete the transaction and/or for the customer user to purchase the one or several products. After the price information has been updated, the process 700 proceeds to block 732 wherein payment is requested. In some embodiments, payment can be requested by prompting the customer user to perform a payment action such as, for example, swiping a credit card, debit card, a stored value card, or the like through a card reader or the like. After payment has been requested, the process 700 proceeds to block 734 wherein payment information is received. In some embodiments, payment information can be received via the providing of payment information to the POS terminal 102. In some embodiments, payment information can be received by, for example, swiping a credit card, debit card, a stored value card, or the like through a card reader or the like.

After the payment information has been received, the process 700 proceeds to block 736 when the payment information is communicated via the first channel. In some embodiments, payment information can include a routing portion and an account identification portion. In some embodiments, the routing portion can be a BIN, and the identification portion can be an account number. A message including the payment information can be generated. This message can include payment information as well as the payment amount. This information can be transmitted to the payment processing network 200, which payment processing network 200 can provide the message to the appropriate authorizer which can be, for example, a financial institution such as a bank or credit institution.

After the payment information has been communicated via the first channel, the process 700 proceeds block 738 wherein payment response is received. In some embodiments, this response is received via the first channel and the payment processing network 200. After the response is been received, the process 700 proceeds to decision state 740 wherein it is determined if payment is accepted by the authorizer. In some embodiments, this determination can be performed by the processor 105 of the POS terminal 102 based on information received in the response. If it is determined that the payment is not accepted by the authorizer, then the process 700 returns to block 710 and proceeds as outlined above.

If it is determined that the payment is accepted by the authorizer, then the process 700 proceeds to block 742 wherein the transaction is completed. In some embodiments, the completion of the transaction can include prompting the customer user to indicate whether or not to accept the terms of the transaction and make payment, and receiving a user input indicating either acceptance of the terms of the transaction or refusal of the terms of the transaction.

After the transaction has been completed, the process 700 proceeds to block 744 wherein the POS terminal 102 identifies offers accepted by the user and communicates these offers to the payment processing network 200 via the first channel. In some embodiments, this step can include the generation of a message including information identifying the accepted offers, the associating of the message with the customer identifier including the routing portion and the identification portion, and communicating the message to the payment processing network 200.

After the accepted offers have been communicated to the payment processing network 200, the process 700 proceeds to block 746 wherein a second channel is identified. In some embodiments, the second channel can be a communication channel 600 that can be used to send and receive information to and from the POS terminal 102. In some embodiments, the second channel can create a communicating connection between the POS terminal 102 and an inventory management module that can include a server, memory, and/or one or several databases including inventory information. After the second channel has been identified, the process 700 proceeds to block 748 wherein the purchased items are communicated via the second channel. In some embodiments, purchased items can be communicated via the second channel to update the one or several inventory databases with information relating to the sale of the one or several products. In some embodiments, this information can identify the product identifiers of those one or several products, the received price for the one or several products, any adjustments made to the price of the one or several products, or any other related information. This information can be formed into a message which can be communicated via the second channel, and can be used to update one or several inventory databases.

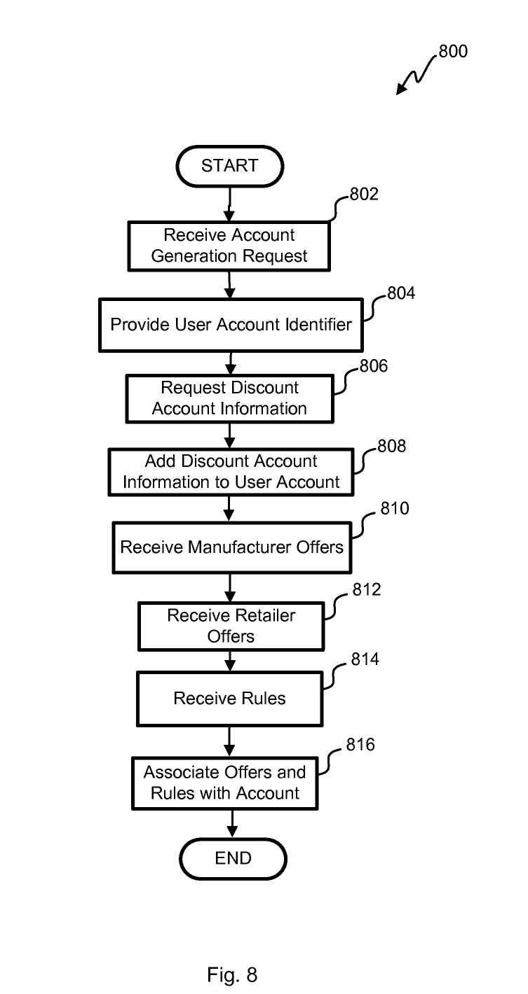

FIG. 8 is a flowchart illustrating one embodiment of a process 800 for creating a user account. The process begins at block 802 wherein an account generation request is received. In some embodiments, this request can be received by the POS terminal 102 and/or by the coupon server 112. In some embodiments, this request can be provided by the user and can include information relating to the user. In some embodiments, after the generation of the user account has been requested, the user account can be generated and information associated with the user account can be stored within the coupon server 112. After the account generation request is received, the process 800 proceeds to block 804 wherein a user account identifier is provided. In some embodiments, the user account identifier can be the customer identifier, and in some embodiments, the user account identifier can be different than the customer identifier. In some embodiments, the providing of the user account identifier can include generation of the user account identifier. In some embodiments, the user account identifier can be generated by the coupon server 112 or a component thereof.

After the user account identifier has been provided, the process 800 proceeds to block 806 wherein user discount information is requested. In some embodiments, this information can relate to pre-existing user discount accounts such as, for example, one or several retailer loyalty programs in which the user previously enrolled. In some embodiments, this discount account information can identify the retailer and program in which the user enrolled, the account number, and/or any other information relating to the discount account. In some embodiments, the discount account information can be received from the user, after which, the process 800 can proceed to block 808 wherein the discount account information is added to the user account.

After the discount account information has been added to the user account, the process 800 proceeds to block 810 wherein manufacturer offers are received. In some embodiments, the manufacturer offers can comprise one or several manufacturer coupons, offers, and/or the like. After the manufacturer offers have been received, the process 800 proceeds to block 812 wherein retailer offers are received. In some embodiments, the retailer offers can include one or several coupons and/or offers associated with a specific retailer. In some embodiments, manufacturer offers and retailer offers can be received from the manufacturer, the retailer, and/or from the user. After the retailer offers have been received, the process 800 proceeds to block 814 wherein rules applicable to at least one of the discount account, the manufacturer offers, and/or the retailer offers are received. After the rules are received, the process 800 proceeds to block 816 wherein the offers and rules are associated with the generated user account.

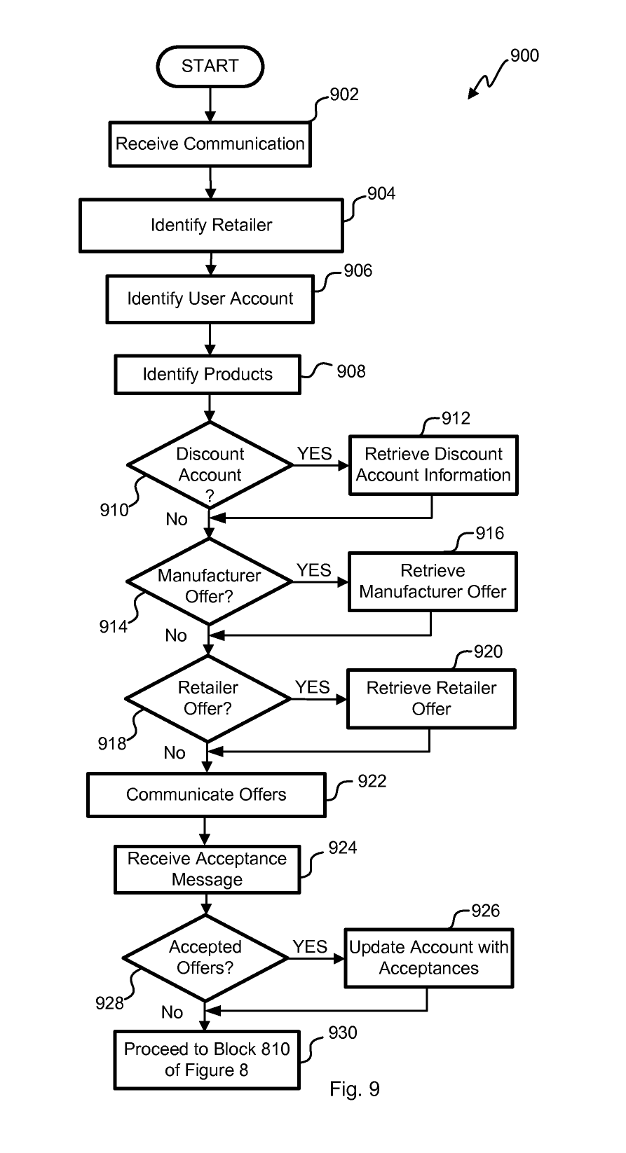

FIG. 9 is a flowchart illustrating one embodiment of a process 900 for processing a coupon over the payment processing network 200 as performed by an authorizer. The process 900 begins at block 902 wherein the communication is received. In some embodiments, the communication can be received by the coupon server 112 from the payment processing network 200. This communication can include the message generated by the POS terminal 102 and can identify one or several products and the user account. After the communication has been received, the process 900 proceeds to block 904 wherein information from the message is used to identify the retailer associated with the POS terminal source of the communication. After the retailer has been identified, the process 900 proceeds to block 906 wherein the user account is identified. In some embodiments, the user account can be identified with information contained within the communication, and specifically with the customer identifier contained within the communication.

After the user account has been identified, the process 900 proceeds to block 908 wherein the products are identified. In some embodiments, the products can be identified using information contained within the communication including, for example, one or several product identifiers, such as one or several UPC codes, contained within the communication. After the product has been identified, the process 900 proceeds to decision state 910 wherein, if information relating to the association between the user account and the discount account is stored at the coupon server 112 and/or the coupon database 114, it is determined if the identified user account is associated with the discount account. In some embodiments, this determination can include querying the memory at the coupon server 112 for user account information. If it is determined that the user account is associated with the discount account, then the process 900 proceeds to block 912 wherein discount account information is retrieved from, for example, the memory associated with the coupon server 112.

After the discount account information has been retrieved, or returning to decision state 910, if it is determined that there is no discount account associated with the user account, the process 900 proceeds to decision state 914 wherein it is determined if there are any relevant manufacturer offers associated with the user account. In some embodiments, for example, this determination can include querying memory at the coupon server 112 for manufacturer offers associated with the user account. If it is determined that one or several relevant manufacturer offers are associated with user account, then the process 900 proceeds to block 916 wherein manufacturer offer information is retrieved from, for example, the memory associated with the coupon server 112.

After the manufacturer offer information has been retrieved, or returning again to decision state 914 if it is determined that there are no manufacturer offers associated with the user account, the process 900 proceeds to decision state 918 wherein it is determined if there is a retailer offer associated with the user account. In some embodiments, the retailer offer can include retailer specific coupons or offers, coupons or offers specific to one or several retailer locations, or the like. In some embodiments, information retrieved from the communication can be used to determine the specific location of the user, which information can be used to identify retailer offers. In some embodiments, for example, the determination of the existence of retailer offers can include querying memory of the coupon server 112 for retailer offers that are associated with the user account. If it is determined that one or several relevant retailer offers are associated with the user account, then the process proceeds to block 920 wherein retailer offer information is retrieved from, for example, the memory associated with the coupon server 112.

After the retailer offer information has been retrieved, or, returning again to decision state 918, if it is determined that there are no available relevant retailer offers, the process 900 proceeds to block 922 wherein the offers are communicated. In some embodiments, the offers can be packaged into a message that can be communicated to the payment processing network 200. After the offers have been communicated to the payment processing network 200, the process 900 can proceed to block 924 wherein an acceptance message is received from the payment processing network 200. In some embodiments, this acceptance message can indicate which, if any, of the offers communicated in block 922 are accepted by the customer user.

After the acceptance message has been received, the process 900 proceeds to decision state 928 wherein it is determined if any of the communicated offers are accepted by the customer user. In some embodiments, this determination can be made by the evaluation of the contents of the message received in block 924. If it is determined that at least one of the offers communicated in block 922 has been accepted, then the process 900 proceeds to block 926 and updates the user account with information identifying the accepted offers. In some embodiments, this update can beneficially allow the application of rules regarding limitations on one or several of the offers such as, for example, rules relating to limits on the number of times that a user can use an offer. After the user account has been updated with indicators of accepted offers, or if it is determined at decision state 928 that none of the offers were accepted, then the process 900 can proceed to block 930 and continue with block 810 of FIG. 8.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of disclosed embodiments is provided to enable any person skilled in the art to make or use the invention. Various modifications to the embodiments will be readily apparent to those skilled in the art, the generic principals defined herein can be applied to other embodiments without departing from spirit or scope of the invention. Thus, the invention is not intended to be limited to the embodiments shown herein but is to be accorded the widest scope consistent with the principals and novel features disclosed herein.

What is claimed is:

1. A method of electronic processing of a coupon via a point-of-sale terminal, the method comprising:
obtaining a product identifier of at least one product, wherein obtaining the product identifier comprises at least one of:
receiving scanned data from a product; and
receiving input data;
identifying a price associated with the product;
obtaining a customer identifier, wherein the customer identifier comprises a routing portion and an identification portion, wherein the routing portion uniquely identifies an intended coupon source, and wherein the identification portion uniquely identifies an account associated with the customer;
generating a communication comprising the product identifier and the customer identifier;
identifying a first communication channel;
transmitting the communication via the first communication channel;
receiving a response via the first communication channel, wherein the response identifies one of:
a coupon;
a coupon code;
a discount;
a refund; and
no discount;
generating a payment amount for the purchase of the product by applying the response to the identified price, wherein the payment amount is based on the identified price and the received response; and
providing payment information via the first channel, wherein the payment information identifies a financial service provider and an account associated with the customer and the financial service provider.

2. The method of claim 1, further comprising determining whether the application of the response to the identified price results in a reduced payment amount with respect to the price associated with the product.

3. The method of claim 2, further comprising requesting a customer input indicating whether to accept the reduced payment amount.

4. The method of claim 3, further comprising generating a second communication comprising the customer identifier and an offer identifier, wherein the offer identifier indicates one of:
that the customer accepted the reduced payment amount; and
that the customer rejected the reduced payment amount.

5. The method of claim 1, wherein the payment information comprises a first portion identifying the financial institution and a second portion identifying the account associated with the customer and the financial institution.

6. The method of claim 1, wherein the payment information identifies one of:
a credit account;
a bank account; and
a stored value account.

7. The method of claim 1, further comprising receiving an indication of acknowledgment of payment approval.

8. The method of claim 7, further comprising receiving a customer input indicating completion of the purchase of the product.

9. The method of claim 7, further comprising identifying a second channel, wherein the second channel communicates with an inventory system.

10. The method of claim 9, further comprising providing an inventory update via the second channel, wherein the inventory update identifies the product purchased by the customer.

11. The method of claim 1, further comprising providing an indicator of coupon status, wherein the indicator of coupon status indicates whether the coupon was used.

12. The method of claim 1, wherein the routing portion of the customer identifier comprises a BIN.

13. The method of claim 1, wherein the product identifier is a universal product code (UPC).

14. A system for processing of a coupon, the system comprising:
an inventory system comprising data relating to sold and stocked inventory;
a point-of-sale (POS) terminal comprising:
a plurality of channels, the plurality of channels comprising:
a first channel is configured for communicating and receiving payment information; and
a second channel communicatively connected with the inventory system;
a processor configured to:
obtain a product identifier of at least one product, wherein the processor is configured to obtain the product identifier by at least one of:
receiving scanned data from a product; and
receiving input data;
identify a price associated with the product;
obtain a customer identifier, wherein the customer identifier comprises a routing portion and an identification portion, wherein the routing portion uniquely identifies an intended coupon source, and wherein the identification portion uniquely identifies an account associated with the customer;
generate a communication comprising the product identifier and the customer identifier;
identify a first communication channel;
transmit the communication via the first communication channel;
receive a response via the first communication channel, wherein the response identifies one of:
a coupon;
a coupon code;
a discount;
a refund; and
no discount;
generate a payment amount for the purchase of the product by applying the response to the identified price, wherein the payment amount is based on the identified price and the received response; and
provide payment information via the first channel, wherein the payment information identifies a financial service provider and an account associated with the customer and the financial service provider.

15. The system of claim 14, further comprising a customer identification unit configured to obtain the customer identifier.

16. The system of claim 15, wherein the customer identification unit comprises one of:
a magnetic card reader; and
an RFID receiver.

17. The system of claim 14, further comprising a transmission unit configured to communicate information via one or more of the plurality of channels.

18. The system of claim 14, further comprising a product identification unit, wherein the product identification unit is configured to obtain an identifier of the product.

19. A point-of-sale (POS) terminal comprising:
a plurality of channels, the plurality of channels comprising:
a first channel is configured for communicating and receiving payment information; and
a second channel communicatively connected with the inventory system;
a processor configured to:
obtain a product identifier of at least one product, wherein the processor is configured to obtain the product identifier by at least one of:
receiving scanned data from a product; and
receiving input data;
identify a price associated with the product;
obtain a customer identifier, wherein the customer identifier comprises a routing portion and an identification portion, wherein the routing portion uniquely identifies an intended coupon source, and wherein the identification portion uniquely identifies an account associated with the customer;
generate a communication comprising the product identifier and the customer identifier;
identify a first communication channel;
transmit the communication via the first communication channel;
receive a response via the first communication channel, wherein the response identifies one of:
a coupon;
a coupon code;
a discount;
a refund; and
no discount;
generate a payment amount for the purchase of the product by applying the response to the identified price, wherein the payment amount is based on the identified price and the received response; and
provide payment information via the first channel, wherein the payment information identifies a financial service provider and an account associated with the customer and the financial service provider.

20. The point of sale terminal of claim 19, wherein the processor is further configured to:
determine whether the application of the response to the identified price results in a reduced payment amount with respect to the price associated with the product;
request a customer input indicating whether to accept the reduced payment amount; and
generate a second communication comprising the customer identifier and an offer identifier, wherein the offer identifier indicates one of:
that the customer accepted the reduced payment amount; and
that the customer rejected the reduced payment amount
